(19) United States
(12) Patent Application Publication
(10) Pub. No.: US 2007/0052734 A1
(43) Pub. Date: Mar. 8, 2007

(54) Method and apparatus for annotating images

(75) Inventors: John V. Skinner JR., New Berlin, WI (US); Fausto J. Espinal, Waukesha, WI (US)

Correspondence Address: QUARLES & BRADY LLP, 411 E. WISCONSIN AVENUE, SUITE 2040, MILWAUKEE, WI, 53202-4497, US

(73) Assignee: General Electric Company

(21) Appl. No.: 11/220,022

(22) Filed: Sep. 6, 2005

(51) Int. Cl. G09G 5/00

(52) U.S. Cl. 345/689

(57) ABSTRACT

A method for displaying an image includes executing a viewer application to display an image. The viewer application is linked to an annotation library including annotation instructions. The annotation instructions are called from the viewer application to display annotation data on the image. An imaging system includes an image data file, an annotation library, and a first workstation. The annotation library includes annotation instruction. The first workstation is operable to execute a viewer application to display an image associated with the image data file. The viewer application is linked to the annotation library and operable to call the annotation instructions to display annotation data on the image.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND OF THE INVENTION

The field of the invention relates generally to medical imaging methods stems, and more particularly to a method and apparatus for annotating images.

Image archiving and communication systems have become an extremely important component in the management of digitized image data, particularly in the field of medical imaging. Such systems often function as central repositories of image data, receiving the data from various sources. The image data is stored and made available to various individuals for viewing, analysis, or diagnosis. There are many types of medical imaging systems. The primary distinction between the different systems is the medical imaging modality that is used, such as, x-ray, magnetic resonance, ultrasound, nuclear, etc.

To facilitate image exchange and viewability across different scanner types and viewing hardware, industry standards have been promulgated defining data formats and transfer protocols. One such standard is the Digital Imaging and Communications in Medicine (DICOM) standard that defines data representation formats and hence achieve platform independence. The DICOM standard was developed by the American College of Radiology and the National Electrical Manufacturers Association to provide a standard for transferring medical images and associated information between devices. The data types in DICOM are well defined, and are hardware independent.

Typically, medical images are annotated with various textual information related to the image. Common annotation data includes patient identification data, date of scan, facility identification data, scanner identification and type data, scan parameters, scan geometry, date of patient coordinate system (e.g., scale, view perspective—left, right, top, anterior, posterior, etc.), DICOM identification, etc.

On occasion, the format or content of the image annotations may be updated. For example, annotation formats may be updated as new image acquisition methods are implemented. Typically, annotation updates are implemented as part of a new software release. The sometimes significant time interval between software releases delays the offering of image annotation updates to customers. In addition, many medical imaging systems offer image viewers that can display images from other imaging modalities. For example, a computed tomography (CT) system may offer a viewer that can display magnetic resonance (MR) images or positron emission tomography (PET) images. As a result, users of a CT system have an interest in receiving upgrades to all types of image annotation.

One technique for providing flexibility for annotation systems involves using annotation commands that interpret string and arithmetic functions at run time. As interpreted functions are significantly slower to execute than compiled string and arithmetic functions, this flexibility comes at the price of performance. In situations where multiple images are drawn or a slide show of images are displayed, this performance degradation is noticeable and hinders usage of the system.

This section of this document is intended to introduce various aspects of art that may be related to various aspects of the present invention described and/or claimed below. This section provides background information to facilitate a better understanding of the various aspects of the present invention. It should be understood that the statements in this section of this document are to be read in this light, and not as admissions of prior art. The present invention is directed to overcoming, or at least reducing the effects of, one or more of the problems set forth above.

### BRIEF SUMMARY OF THE INVENTION

One aspect of the present invention is seen in a method for displaying an image. The method includes executing a viewer application to display an image. The viewer application is linked to an annotation library including annotation instructions. The annotation instructions are called from the viewer application to display annotation data on the image.

Another aspect of the present invention is seen in an imaging system including an image data file, an annotation library, and a first workstation. The annotation library includes annotation instruction. The first workstation is operable to execute a viewer application to display an image associated with the image data file. The viewer application is linked to the annotation library and operable to call the annotation instructions to display annotation data on the image.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made, therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a simplified block diagram of an imaging system in accordance with one aspect of the present invention; and

FIG. 2 is simplified flow diagram of a method for generating compiled on program instructions and annotating an image in the system of FIG. 1; and

FIGS. 3 and 4 illustrate exemplary images with differing image annotation formats.

### DETAILED DESCRIPTION OF THE INVENTION

One or more specific embodiments of the present invention will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

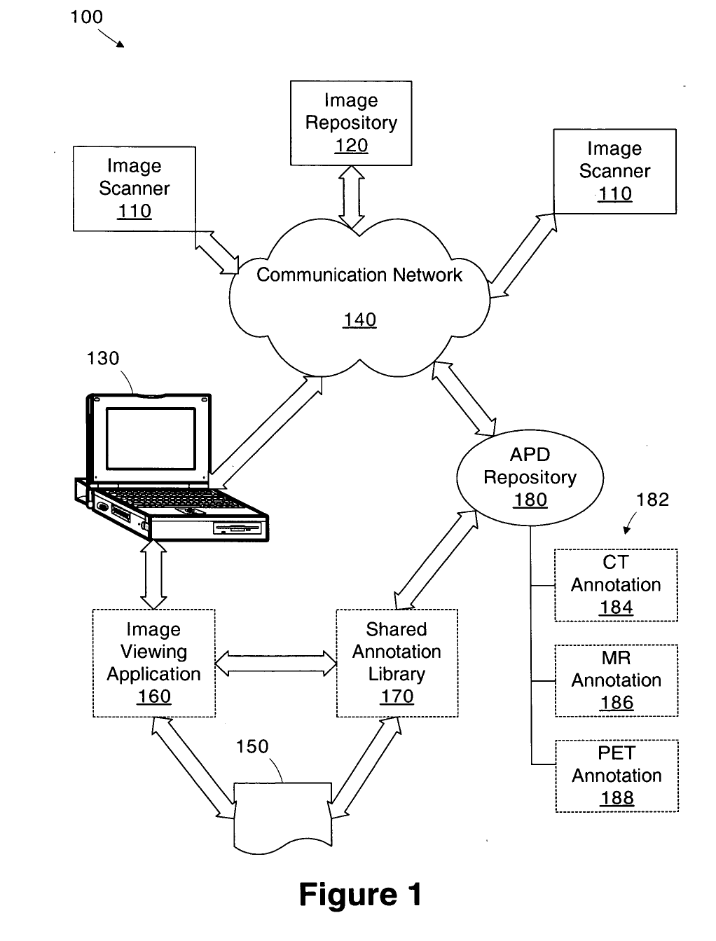

Referring now to FIG. 1, a simplified block diagram of an imaging system 100 in accordance with one aspect of the present invention is shown. The imaging system 100 includes one or more image scanners 110, one or more image repositories 120, and an image viewing workstation 130, all communicating over a communication network 140. An image repository 120 may be implemented by a general purpose computer or workstation executing a database software application that includes one or more data structures for storing image data. In some embodiments, the image scanners 110 may also function as image repositories, and where the term repository is used, it may refer either to an image scanner 110 or an image repository 120. The communication network 140 may be of a variety of forms, including, but not limited to, a local area network (LAN), a wide area network (WAN), the Internet, etc. The communication network 140 may employ hard-wired (e.g., Ethernet) or wireless (e.g. 802.11) connections. Although the image viewing workstation 130 is illustrated as a separate entity, it is contemplated that the viewing functionality may be integrated into a scanner 110.

The application of the present invention is not limited to any particular imaging application or image type. Exemplary image include computed tomography (CT) images, x-ray images, magnetic resonance (MR) images, positron emission tomography (PET) images, etc.

In general operation, the image viewing workstation 130 accesses an image 150 on a scanner 110 or repository 120 and displays the image for a user. Annotation data is superimposed over the image data to provide various information to the user. An exemplary, but not exhaustive or limiting, list of annotation data includes patient identification data, date of scan, facility identification data, scanner identification and type data, scan parameters, scan geometry, date of patient coordinate system (e.g., scale, view perspective—left, right, top, anterior, posterior, etc.), and DICOM identification.

The image viewing workstation 130 executes an image viewing application 160 for displaying the image 150. The image viewing application 160 does not include the program instructions for annotating the image, but rather interfaces with a shared annotation library 170 that includes compiled annotation program instructions. The construct of the shared annotation library 170 and the interface between it and the image viewing application 160 is described in greater detail below.

In general, because the annotation program instructions are included in the shared annotation library 170, the image viewing application 160 need not be recompiled to change the annotation format. Hence, a new software release is not required to implement an annotation change. New annotation formats can be distributed to users of various software releases to increase the consistency of image display formats across platforms and organizations. If an annotation format for a particular type of image (e.g., CT) changes, the shared annotation library 170 can be updated based on the change. Subsequently, image viewing applications 160 for other types of image scanners 110 (e.g., MR or PET) can access the updated annotation format.

Annotation formats are defined in accordance with an Annotation Presentation Description (APD) language. Tables 1 and 2 illustrate and exemplary APD code for defining an annotation format for an image. The code examples include a subset of an annotation file used to display a patient's date of birth on an image. An annotation file for the entire image includes annotation data for each annotated field. The reduced subset is provided for illustrative purposes to aid in understanding of the present invention. Annotation formats are stored in an APD repository 180. Each image type may have an associated APD annotation file 182, such as the CT annotation file 184, MR Annotation file 186, and PET annotation file 188 illustrated in FIG. 1.

TABLE 1
Annotation Code

```
<?xml version = “1.0” encoding=“UTF-8”?>
<apd SOP=“1.2.on-and-on” name = “CT”>
<version syntax=“0.1” content=“0.5”/>
<declarations>
...
<dicomVar name=“birthDate” type=“string” group=“0010”
element=“0030”/>
...
<runtimeVar name=“lang” type=“string” initial = “en_US”/>
...
<runtimeVar name=“timedateFormat” type=“string” initial=“1”/>
...
</declarations>
<expressions>
...
  <set name=“p_byear”> <![CDATA[
        if (!isblank(birthDate))
          then
          int(midstr(birthDate,0,4))
          else
          0
        endif
    ]]> </set>
    <set name=“ABirthDate”> <![CDATA[
        if(!isblank(birthDate))
          then
          “Born:” + if(timedateFormat == “1” || timedateFormat ==
          “4”)
            then
            MonthOfBirth + “ ” + p_bdate + “ ” + p_byear
            else
            if(timedateFormat == “2” || timedateFormat == “5”)
              then
              “ ” + p_bdate + “ ” + MonthOfBirth + “ ” + p_byear
              else
              “ ” + p_bdate + “ ” + MonthOfBirth + “ ” + p_bdate
            endif
          endif
        endif
  ]]> </set>
...
</expressions>
...
<layout>
...
      <annoLine location=“NE” line=“4” dir=“H”>
      <seg exp=“ABirthDate” group=“Date_Of_Birth” priority=“7”>
  <desc>
    <i18n lang=“en_US” string=“patient birth date ”/>
    <i18n lang=“fr” string=“date de naissance du patient”/>
    <i18n lang=“de” string=“Geb.datum des Patienten”/>
    <i18n lang=“it” string=“Data di nascita paziente”/>
    <i18n lang=“es_MX” string=“fecha de nac. del paciente”/>
    <i18n lang=“pt_BR” string=“data de nascimento do paciente”/>
  </desc>
      </seg>
      </annoLine>
</layout>
</apd>
```

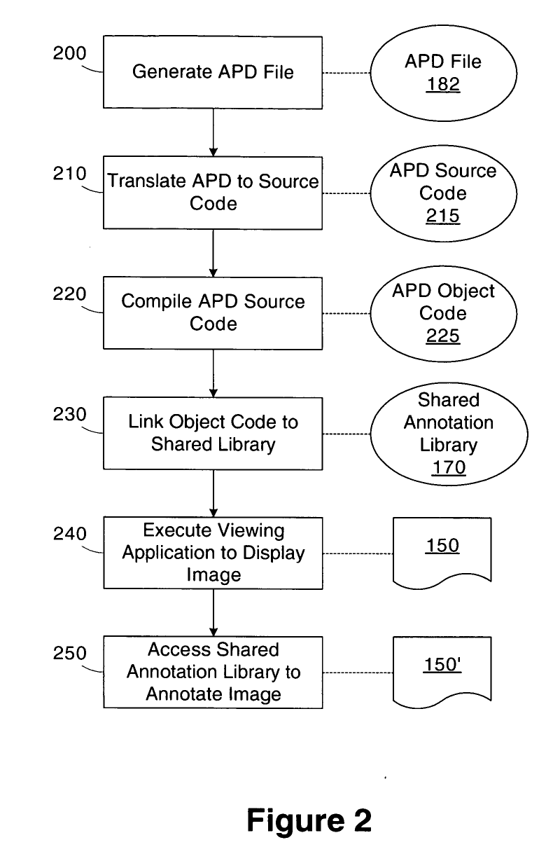

Turning now to FIG. 2, a simplified flow diagram of a method for generating compiled annotation program instructions from the APD annotation files 182 and annotating an image is described. In block 200, an APD annotation file 182 is generated. The APD annotation file 182 defines where various annotation data is to appear on an image.

In block 210, the APD instructions are translated into source code to generate an APD source code file 215. Based on the annotation information included in the APD annotation file 182 source code instructions may be generated to create the screen call commands to place the data in the appropriate positions. For example, Java or C++ programming languages may be used. The annotation data may come from a variety of locations. The source code includes instructions that access the appropriate data source for the annotation information. For example, annotation data, such as patient data and scan parameters, may be encoded in the DICOM image file. In other cases, annotation data controlled by the image viewing application 160, such as scale and coordinate system data, may be provided by the image viewing application 160 as an argument in the program call that requests the display of the annotation data. Based on knowledge of the DICOM image format and the data provided by the image viewing application 160, a conversion software application may be created that autonomously generates the APD source code file 215 from the APD annotation file 182. To support proper interfacing with the image viewing application 160, the functions and methods implemented in the APD source code file 215 should not change between versions of the shared annotation library 170.

In block 220, the APD source code file 215 is complied to generate a APD object code file 225. In block 230, the APD object code file 225 is linked to the shared annotation library 170. Techniques and tools for compiling the APD source code file 215 and linking the APD object code file 225 to create a shared library for the particular programming software used are well known to those of ordinary skill in the art and are commercially available.

In block 240, the image viewing application 160 is executed and an image 150 is displayed. During initialization a system loader loads the image viewing application 160 and links it to the shared annotation library 170. The programming languages C or C++ implemented under a Linux operating system offer a shared library functionality that allows such linking to occur. The Java programming platform offers similar functionality using a class loader function that loads class definitions at run-time.

In block 250, the shared annotation library 170 is accessed by the image viewing application 160 to annotate the image, represented by the image 150′. Again, the image viewing application 160 either provides the annotation data in its calls to the shared annotation library 170 or the program instructions in the shared annotation library 170 access the annotation data directly from the DICOM image file.

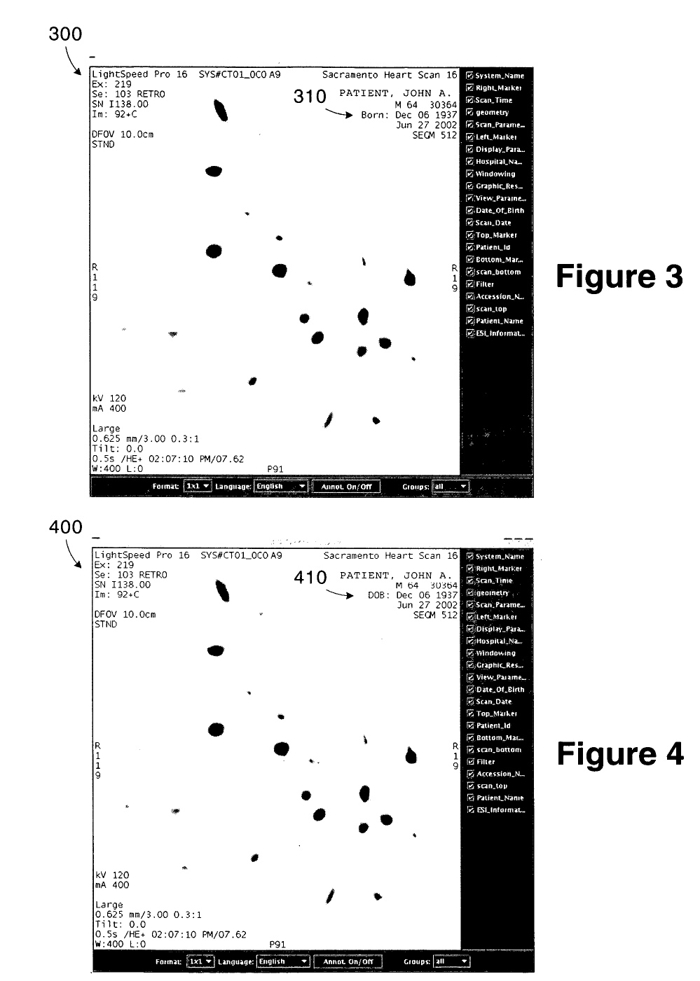

FIG. 3 illustrates an exemplary image 300 including annotation data in accordance with a first APD annotation file 182, as illustrated above in Table 1. The APD annotation file 182 includes annotation code for displaying a date of birth field 310 annotated on the medical image 300. Of course, the APD annotation file 182 also includes annotation code for displaying the other fields displayed on the image 300, but for ease of illustration, and to avoid obscuring the present invention, this additional annotation code is not included in Table 1.

FIG. 4 illustrates an image 400 similar to the image of FIG. 2, but with a different annotation format, defined by a modified APD annotation file 182 provided below in Table 2. Note that a modified date of birth field 410 is illustrated. The field label for the date of birth was changed from “Born:” in FIG. 3, to “DOB:” in FIG. 4. The line of code that was modified is highlighted in bold below in Table 2.

TABLE 2
Revised Annotation Code

```
<?xml version = “1.0” encoding=“UTF-8”?>
<apd SOP=“1.2.on-and-on” name = “CT”>
<version syntax=“0.1” content=“0.5”/>
<declarations>
...
<dicomVar name=“birthDate” type=“string” group=“0010”
element=“0030”/>
...
<runtimeVar name=“lang” type=“string” initial = “en_US”/>
...
<runtimeVar name=“timedateFormat” type=“string” initial=“1”/>
...
</declarations>
<expressions>
...
  <set name=“p_byear”> <![CDATA[
      if(!isblank(birthDate))
        then
        int(midstr(birthDate,0,4))
        else
        0
      endif
  ]]> </set>
  <set name=“ABirthDate”> <![CDATA[
        if(!isblank(birthDate))
          then
          “DOB:” + if(timedateFormat == “1” || timedateFormat ==
          “4”)
            then
            MonthOfBirth + “ ” + p_bdate + “ ” + p_byear
            else
            if(timedateFormat == “2” || timedateFormat == “5”)
              then
              “ ” + p_bdate + “ ” + MonthOfBirth + “ ” + p_byear
              else
              “ ” + p_bdate + “ ” + MonthOfBirth + “ ” + p_bdate
            endif
          endif
        endif
  ]]> </set>
...
</expressions>
...
<layout>
...
      <annoLine location=“NE” line=“4” dir=“H”>
      <seg exp=“ABirthDate” group=“Date_Of_Birth” priority=“7”>
  <desc>
    <i18n lang=“en_US” string=“patient birth date ”/>
    <i18n lang=“fr” string=“date de naissance du patient”/>
    <i18n lang=“de” string=“Geb.datum des Patienten”/>
    <i18n lang=“it” string=“Data di nascita paziente”/>
    <i18n lang=“es_MX” string=“fecha de nac. del paciente”/>
    <i18n lang=“pt_BR” string=“data de nascimento do paciente”/>
  </desc>
      </seg>
      </annoLine>
</layout>
</apd>
```

This simple example illustrates how the annotation format can be updated based on convention changes, software revisions, and the like, to alter the annotation information without requiring the image viewing application to be recompiled. The flexible annotation architecture provided by the shared annotation library 170 has numerous advantages. Because the shared annotation library 170 includes compiled code, as opposed to interpreted instructions, the performance of the image viewing application 160 is enhanced. Moreover, because the shared annotation library 170 may be updated and distributed independently of the image viewing application 160, annotation format changes can be readily implemented without requiring new software releases. The APD repository 180 and resulting shared annotation library 170 provide current annotation formats for different image types that may be accessed by image scanners 110 regardless of their native image type.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method for displaying an image, comprising:
executing a viewer application to display an image;
linking the viewer application to an annotation library, the annotation library including annotation instructions;
calling the annotation instructions from the viewer application to display annotation data on the image.

2. The method of claim 1, wherein the annotation library includes compiled annotation instructions.

3. The method of claim 1, wherein the annotation data comprises at least one of patient identification data, scan data, facility data, scanner data, and patient coordinate system data.

4. The method of claim 1, wherein the annotation library includes a plurality of sets of annotation instructions, each set being associated with an image type.

5. The method of claim 4, wherein the image type comprises at least one of a magnetic resonance image type, a computed tomography image type, an x-ray image type, and a positron emission tomography image type.

6. The method of claim 4, wherein the viewer application is associated with a first image type, and calling the annotation instructions comprises calling the annotation instructions for a set associated with an image type different than the first image type.

7. The method of claim 1, further comprising generating the annotation library.

8. The method of claim 7, wherein generating the annotation library further comprises:
generating annotation instruction source code;
compiling the annotation source code to generate annotation instruction object code; and
linking the annotation object code to the annotation library.

9. The method of claim 8, further comprising:
generating an annotation format list; and
generating the annotation instruction source code based on the annotation format list.

10. An imaging system, comprising:
an image data file;
an annotation library including annotation instructions;
a first workstation operable to execute a viewer application to display an image associated with the image data file, the viewer application being linked to the annotation library and operable to call the annotation instructions to display annotation data on the image.

11. The system of claim 10, wherein the first workstation comprises an image scanner.

12. The system of claim 10, wherein the annotation library includes compiled annotation instructions.

13. The system of claim 10, wherein the annotation data comprises at least one of patient identification data, scan data, facility data, scanner data, and patient coordinate system data.

14. The system of claim 11, wherein the annotation library includes a plurality of sets of annotation instructions, each set being associated with an image type.

15. The system of claim 14, wherein the image type comprises at least one of a magnetic resonance image type, a computed tomography image type, an x-ray image type, and a positron emission tomography image type.

16. The system of claim 14, wherein the first workstation comprises an image scanner having a first type, the image file has a second type different than the first type, and the viewer application is operable to call a set of annotation instructions for the second type.

17. A system comprising:
means for displaying an image;
means for linking the means for displaying the image to an annotation library including annotation instructions;
means for calling the annotation instructions from the means for displaying the image to display annotation data on the image.
